(19) United States
(12) Patent Application Publication
(10) Pub. No.: US 2021/0064150 A1
(43) Pub. Date: Mar. 4, 2021

(54) PROCESS FOR FORMING A TWO LAYER PLASTIC DEVICE WITH TEXTURES OR DRAWINGS THEREON AND DEVICES MADE OF THE SAME

(71) Applicant: JUI-TSAI CHEN, Taipei Hsien (TW)

(72) Inventor: JUI-TSAI CHEN, Taipei Hsien (TW)

(21) Appl. No.: 17/094,788

(22) Filed: Nov. 10, 2020

Related U.S. Application Data
(63) Continuation-in-part of application No. 16/274,253, filed on Feb. 13, 2019.

(51) Int. Cl. G06F 3/02; B29C 45/14

(52) U.S. Cl. CPC G06F 3/0202; B29L 2031/7676; B29C 2045/14368; B29C 45/14344

(57) ABSTRACT

A process for forming a two layer plastic device with textures or drawings thereon and a structure formed by the structure are provided. An inner bottom layer has textures or drawings on the surface thereof which includes at least one enclosing space. A through hole is formed on the enclosing space so that the masking material can be filled into the space between the outer mold and the inner mold. Then the masking material enters into the enclosing space through the through hole. As a result, only one mold (the outer mold) is necessary for forming the masking layer, while in the prior art, two molds are needed. The whole process can be completed mechanically without any manual operation. A color of the masking layer may be different from that of the inner bottom layer so that the textures or drawings clearly exposes on the surface of the masking layer.

The present invention is an application of continuation in part (CIP) of U.S. patent application Ser. No. 16/274,253, filed at Feb. 13, 2019, which is invented by and assigned to the applicant of the present invention, and thus the contents of the U.S. patent application Ser. No. 16/274,253 are incorporated into the present invention as a part of the present invention.

### FIELD OF THE INVENTION

The present invention is related to plastic structures, and in particular to a process for forming a two layer plastic device with textures or drawings thereon and the devices made of the same.

### BACKGROUND OF THE INVENTION

In forming a prior art double layer plastic structure, such as a key pad, an inner bottom layer 10′ is formed firstly. An outer surface of the inner bottom layer 10′ has protruded textures 21′ or drawings 20′. The textures 21′ or drawings 20′ are formed with an enclosing space 30′, that is: a part or whole of the textures 21′ or drawings 22′ is formed with an enclosing space 30′. A through hole 40′ is formed in the bottom side of the enclosing space 30′. An outer surface of the inner bottom layer 10′ near the enclosing space 30′ is formed with another through hole 41′. A shallow tunnel 45′ is formed in the inner surface of the inner bottom layer 10′ and the two through holes 40′, 41′.

In manufacturing of the masking layer 70′, the periphery and interior of the masking material 71′ are clamped by two molds 200′. The masking material 71′ are filled into the through hole 40′ and then flows along the shallow tunnel 45′, and then to the through hole 40′ to be injected into the interior of the enclosing space 30′ so as to form the masking layer 70 with the textures 21′ or drawings 20′ expose thereon.

In above mentioned prior art, in manufacturing of the masking layer 70′, the periphery and the interior of the inner bottom layer 10′ are clamped by two molds. In the manufacturing process of the prior art, a worker serves to place the inner bottom layer 10′ to be between the two molds 200′ for making the masking layer 70. This process is time and labor consumed so as to prolong the whole process and thus not economic.

The object of the present invention is to provides a novel way which can improve the defects in the prior art.

### SUMMARY OF THE INVENTION

Accordingly, the object of the present invention is to provide a process for forming a two layer plastic device with textures or drawings thereon and a structure formed by the structure. An inner bottom layer has textures or drawings on the surface thereof which includes at least one enclosing space. A through hole is formed on the enclosing space so that the masking material can be filled into the space between the outer mold and the inner mold. Then the masking material enters into the enclosing space through the through hole. As a result, only one mold (the outer mold) is necessary for forming the masking layer, while in the prior art, two molds are needed. The whole process can be completed mechanically without any manual operation. A color of the masking layer may be different from that of the inner bottom layer so that the textures or drawings clearly exposes on the surface of the masking layer.

To achieve above object, the present invention provides a process for forming a two layer plastic device with textures or drawings thereon, comprising the steps of: forming an inner bottom layer; wherein an outer surface of the inner bottom layer has protruded textures or drawings; the textures or drawings are formed with an enclosing space, that is: a part or whole of the textures or drawings is formed with an enclosing space; a through hole is formed between a wall of the enclosing space and an outer space out of the enclosing space; locating the inner bottom layer under an outer mold, so that upper sides of the textures or drawings resists against an inner surface of the outer mold; then filling masking material into a space between the outer mold and the inner mold; and then the masking material being filled into an interior of the enclosing space through the through hole at the lateral side of the enclosing space; and removing the outer mold so that the masking material is formed as a masking layer; an outer surface of the masking layer exposing the protruded textures or drawings on the surface of the inner bottom layer.

Moreover, the present invention provides a two layer plastic device with textures or drawings thereon comprising: an inner bottom layer; an outer surface of the inner bottom layer having protruded textures or drawings; the textures or drawings being formed with an enclosing space; that is: a part or whole of the textures or drawings is formed with an enclosing space; a through hole is formed between a wall of the enclosing space and an outer space; and

a masking layer covering outer sides of the inner bottom layer; an outer surface of the masking layer exposing the textures and drawings original on the inner bottom layer.

### BRIEF DESCRIPTION OF THE DRAWINGS

FIG. 1 is a schematic cross section view showing the inner bottom layer of the prior art.

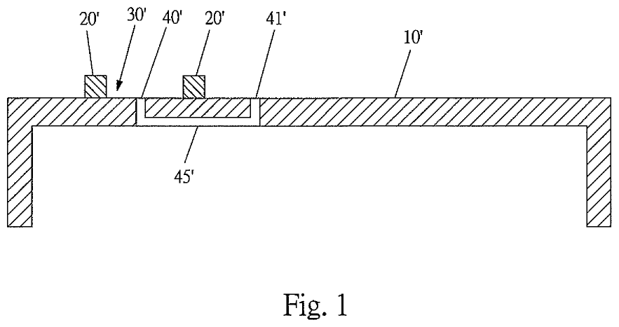

FIG. 2 is a schematic cross section view showing the manufacturing of the prior art.

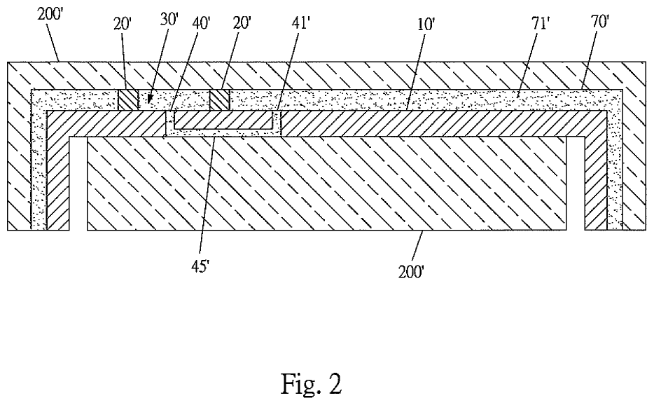

FIG. 3 is a schematic view of the inner bottom layer of the present invention.

FIG. 4 is a partial enlarged schematic view of FIG. 3.

FIG. 5 is a back side schematic view of FIG. 3.

FIG. 6 is a partial enlarged schematic view of FIG. 5.

FIG. 7 is a schematic cross section view of the process of the present invention.

FIG. 8 is another schematic cross section view of the process of the present invention.

FIG. 9 is a further schematic cross section view of the process of the present invention.

FIG. 10 is a perspective view showing the structure according to the process of the present invention.

FIG. 11 is a schematic view showing the manufacturing process of the present invention.

FIG. 12 is a schematic view showing another process of the present invention.

FIG. 13 is another schematic view showing another process of the present invention.

FIG. 14 is a partial enlarged schematic view of FIG. 13.

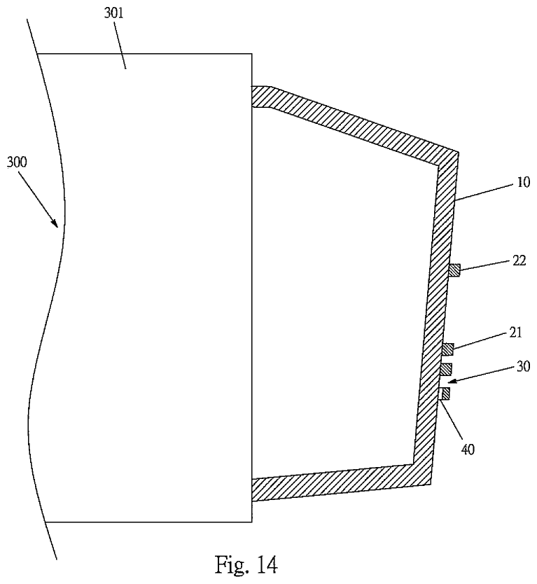

FIG. 15 is another schematic view showing another process of the present invention.

FIG. 16 is a further schematic view about another process of the present invention.

FIG. 17 is a partial enlarged view of FIG. 16.

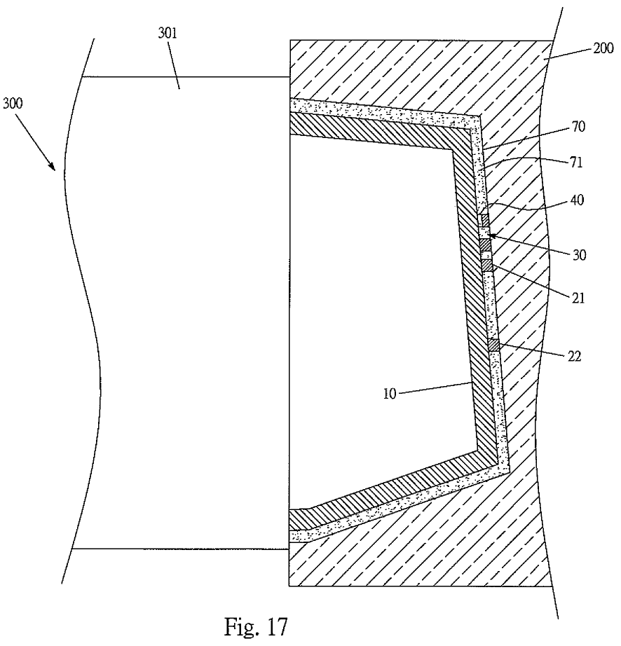

FIG. 18 is a schematic view of FIG. 17, where the outer mold is removed.

FIG. 19 is a perspective view showing the structure according to another process of the present invention.

FIG. 20 is a flow diagram showing the another process.

FIG. 21 is a schematic view showing the application of the present invention.

FIG. 22 is a lower schematic view of FIG. 21.

FIG. 23 is a schematic cross section view along line A-A′ of FIG. 21.

FIG. 24 shows a schematic view about the inner bottom layer of the present invention.

FIG. 25 is a back side view of FIG. 24.

FIG. 26 is a partial enlarged view of FIG. 25.

FIG. 27 is a schematic view showing the applications of the present invention.

FIG. 28 is a lower schematic view of FIG. 27.

FIG. 29 is a schematic cross section view along line A-A′ of FIG. 27.

FIG. 30 is a schematic cross section view along line C-C′ of FIG. 27.

FIG. 31 is a schematic view showing the inner bottom layer of the application of the present invention.

FIG. 32 is a back side view of FIG. 31.

FIG. 33 is an enlarged schematic view of FIG. 32.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

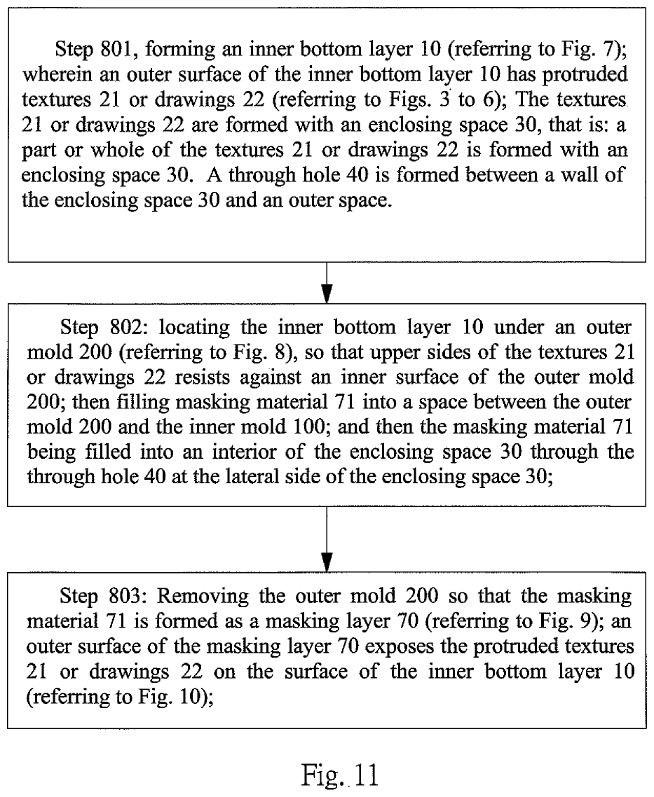

With reference to FIG. 11, the structure of the present invention is illustrated. The present invention includes the following elements.

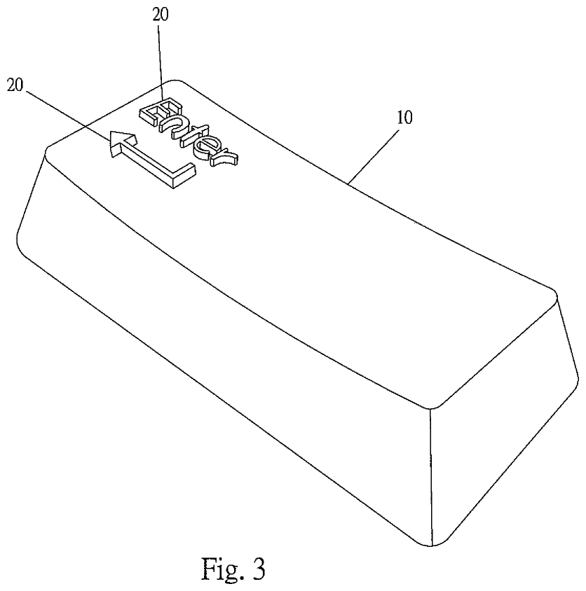

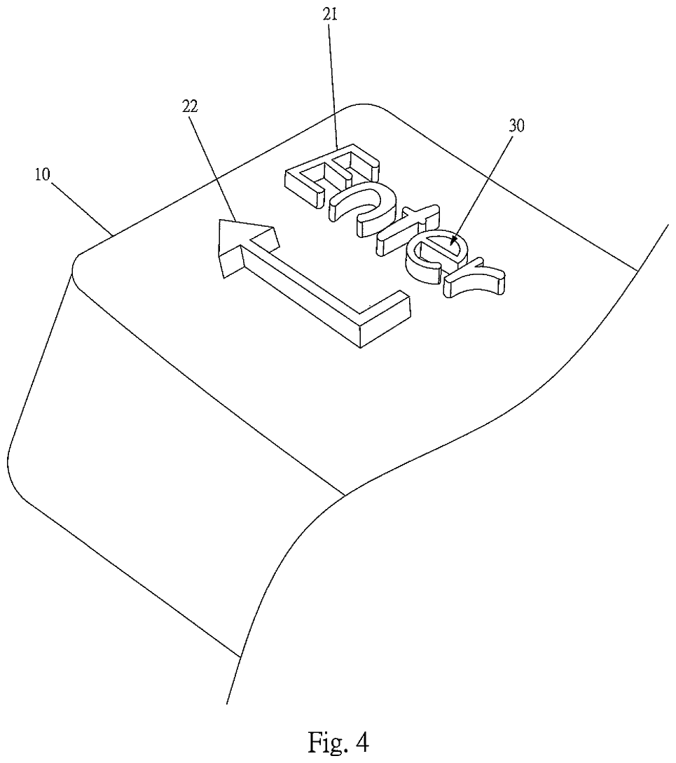

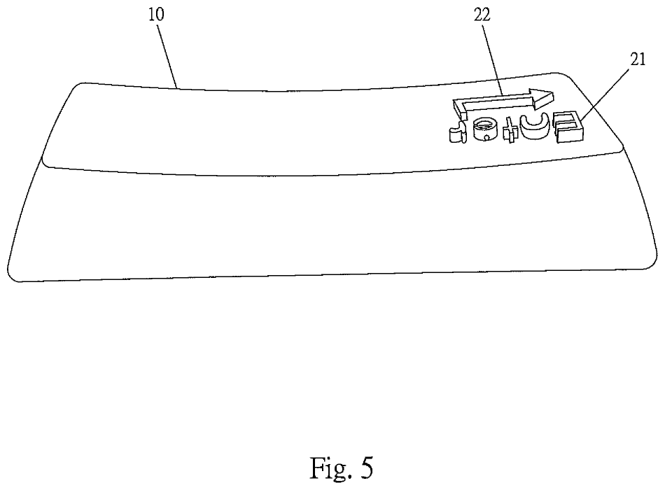

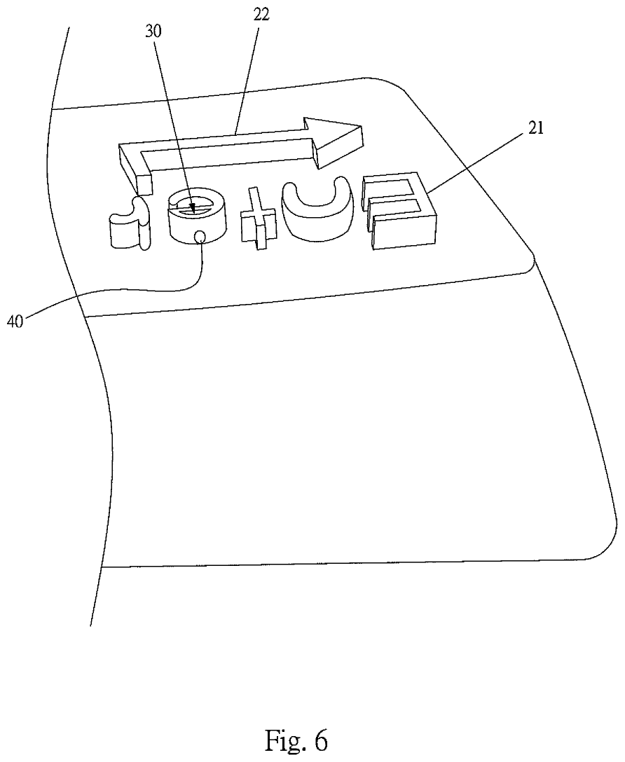

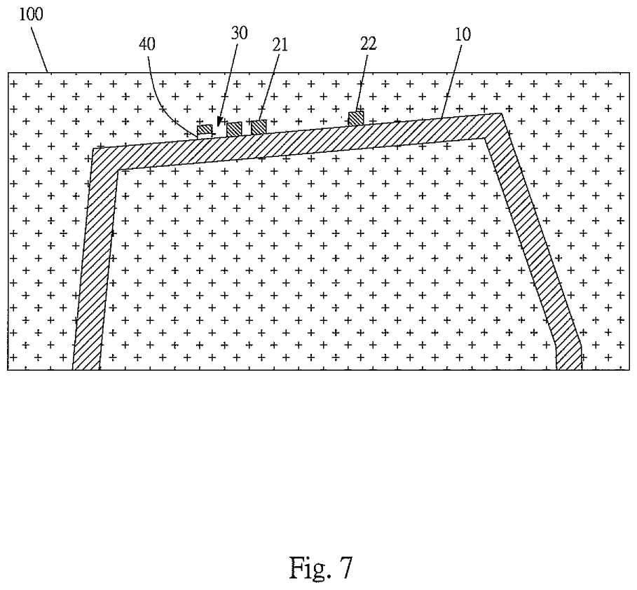

Step 801, forming an inner bottom layer 10 (referring to FIG. 7); Wherein an outer surface of the inner bottom layer 10 has protruded textures 21 or drawings 22 (referring to FIGS. 3 to 6); The textures 21 or drawings 22 are formed with an enclosing space 30, that is: a part or whole of the textures 21 or drawings 22 is formed with an enclosing space 30. A through hole 40 is formed between a wall of the enclosing space 30 and an outer space.

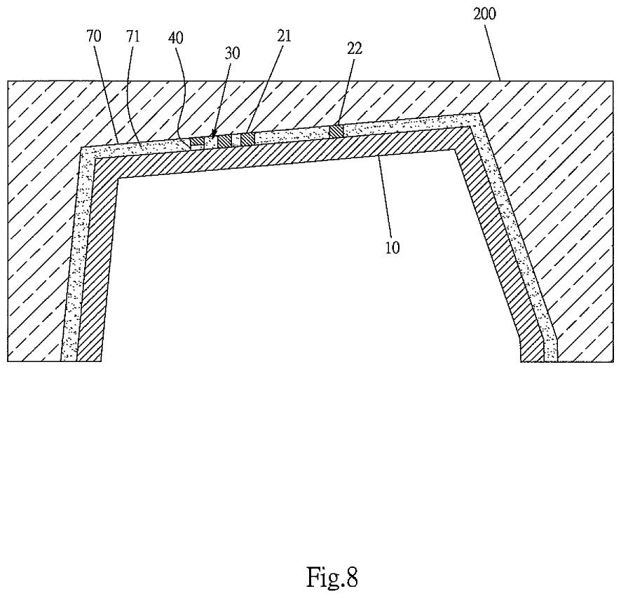

Step 802: locating the inner bottom layer 10 under an outer mold 200 (referring to FIG. 8), so that upper sides of the textures 21 or drawings 22 resists against an inner surface of the outer mold 200; then filling masking material 71 into a space between the outer mold 200 and the inner mold 100; and then the masking material 71 being filled into an interior of the enclosing space 30 through the through hole 40 at the lateral side of the enclosing space 30;

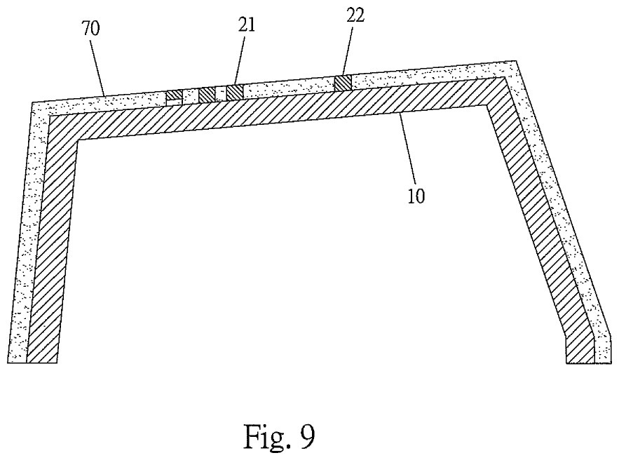

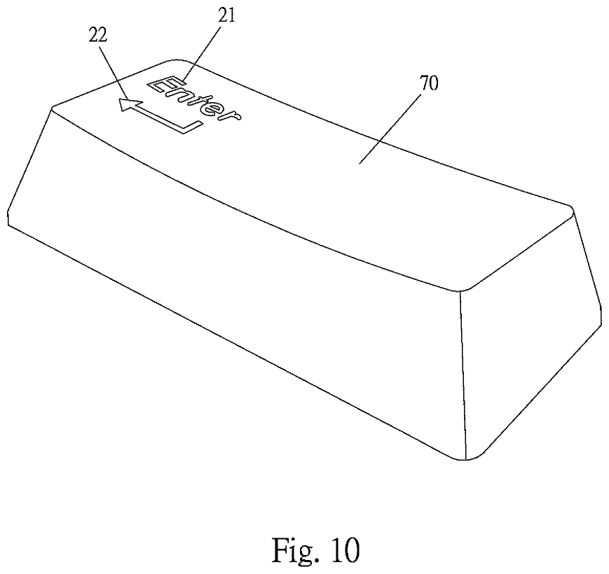

Step 803: Removing the outer mold 200 so that the masking material 71 is formed as a masking layer 70 (referring to FIG. 9); an outer surface of the masking layer 70 exposes the protruded textures 21 or drawings 22 on the surface of the inner bottom layer 10 (referring to FIG. 10);

Preferably, a color of the masking layer 70 is different from that of the inner bottom layer 10 so that the textures 21 or drawings 22 on the outer surface of the inner bottom layer 10 clearly exposes on the surface of the masking layer 70.

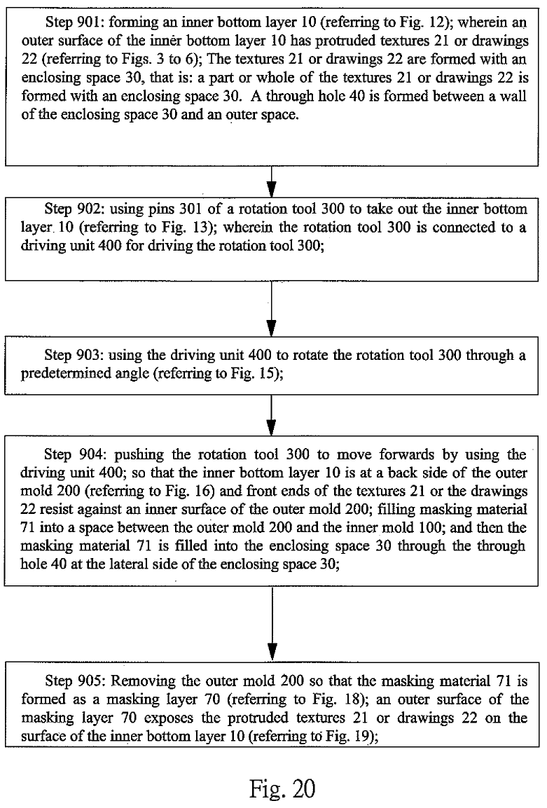

The process for manufacturing of the present invention is illustrated, in that a rotation tool 300 is used without manual operation. See FIG. 20, the structure of the present invention which is made by another process is illustrated. The process includes the following steps of:

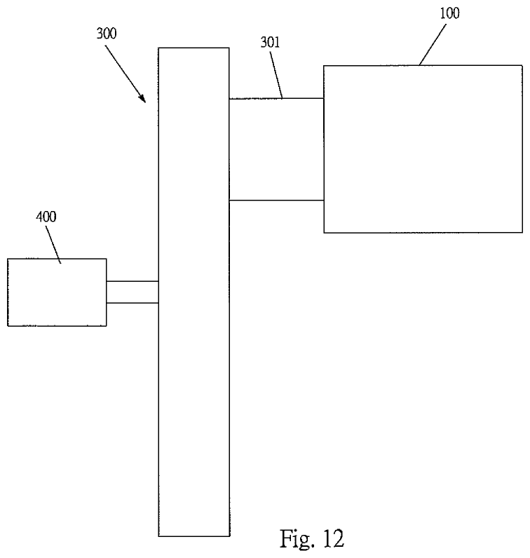

Step 901: forming an inner bottom layer 10 (referring to FIG. 12); wherein an outer surface of the inner bottom layer 10 has protruded textures 21 or drawings 22 (referring to FIGS. 3 to 6); The textures 21 or drawings 22 are formed with an enclosing space 30, that is: a part or whole of the textures 21 or drawings 22 is formed with an enclosing space 30. A through hole 40 is formed between a wall of the enclosing space 30 and an outer space.

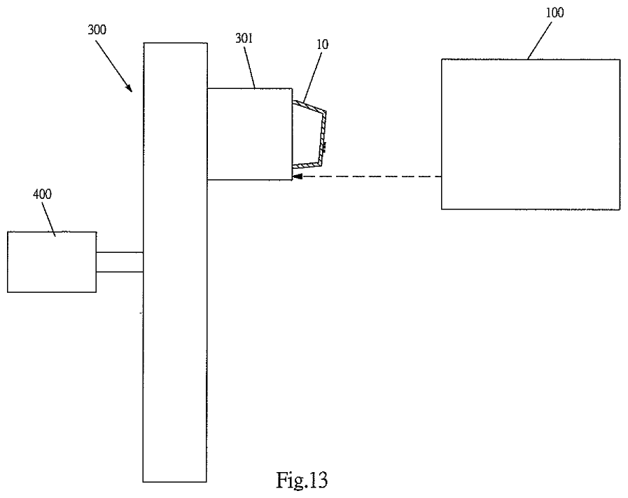

Step 902: using pins 301 of a rotation tool 300 to take out the inner bottom layer 10 (referring to FIG. 13); wherein the rotation tool 300 is connected to a driving unit 400 for driving the rotation tool 300;

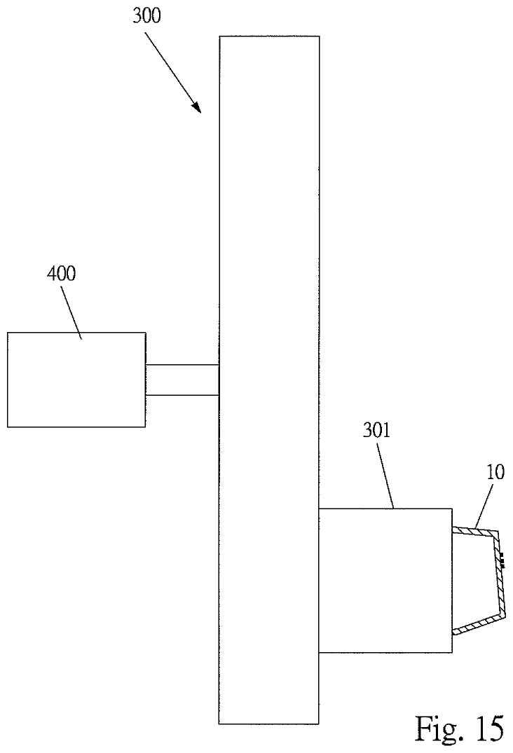

Step 903: using the driving unit 400 to rotate the rotation tool 300 through a predetermined angle (referring to FIG. 15);

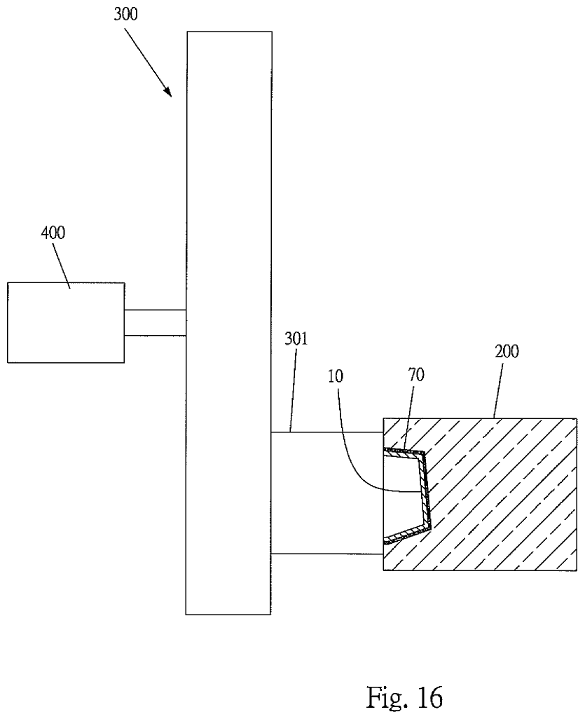

Step 904: pushing the rotation tool 300 to move forwards by using the driving unit 400; so that the inner bottom layer 10 is at a back side of the outer mold 200 (referring to FIG. 16) and front ends of the textures 21 or the drawings 22 resist against an inner surface of the outer mold 200; filling masking material 71 into a space between the outer mold 200 and the inner mold 100; and then the masking material 71 is filled into the enclosing space 30 through the through hole 40 at the lateral side of the enclosing space 30;

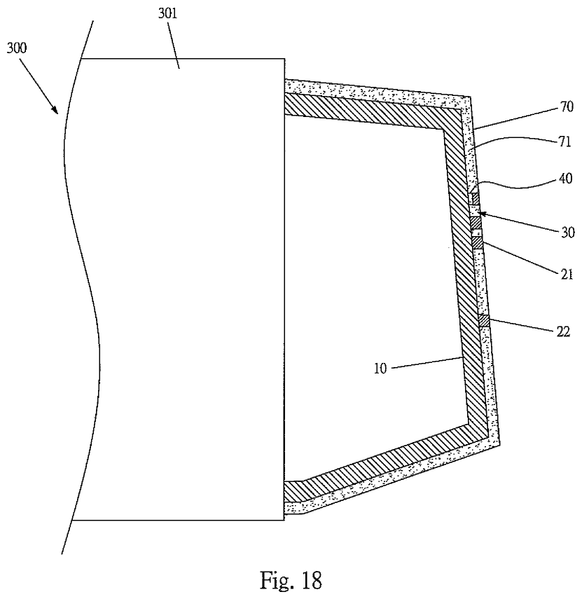

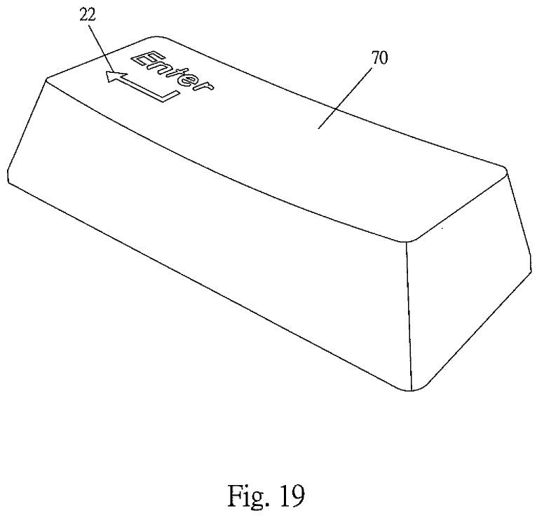

Step 905: Removing the outer mold 200 so that the masking material 71 is formed as a masking layer 70 (referring to FIG. 18); an outer surface of the masking layer 70 exposes the protruded textures 21 or drawings 22 on the surface of the inner bottom layer 10 (referring to FIG. 19);

Preferably, a color of the masking layer 70 is different from that of the inner bottom layer 10 so that the textures 21 or drawings 22 on the outer surface of the inner bottom layer 10 clearly exposes on the surface of the masking layer 70.

Therefore, the whole process is made mechanically without manual operation

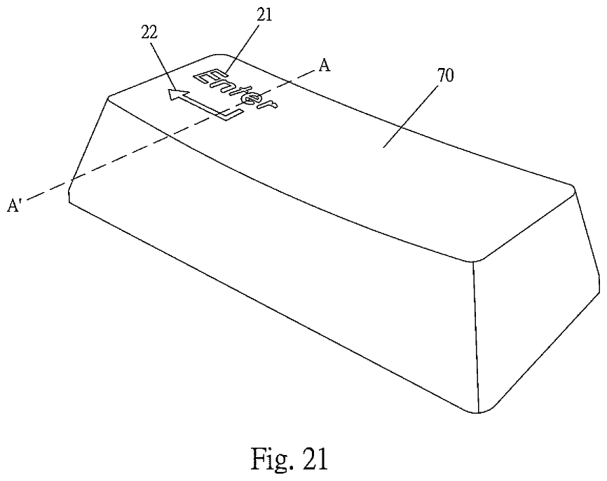

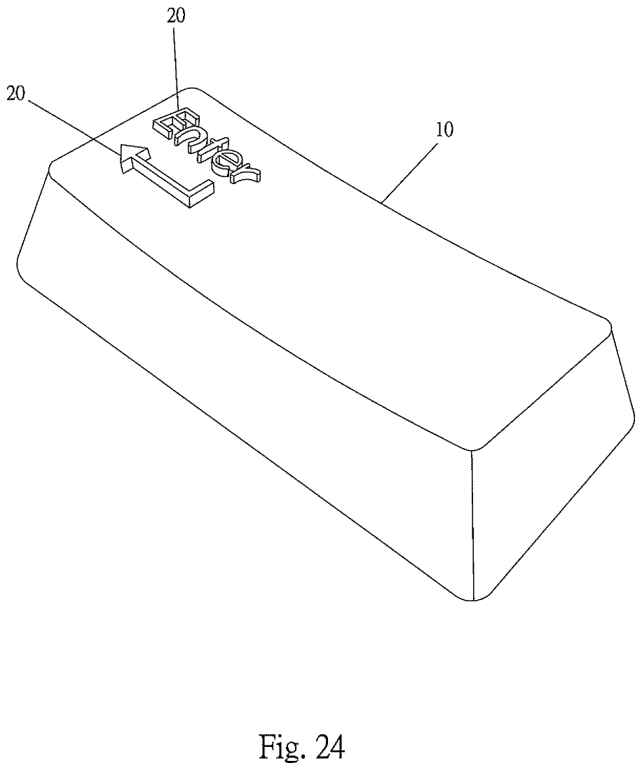

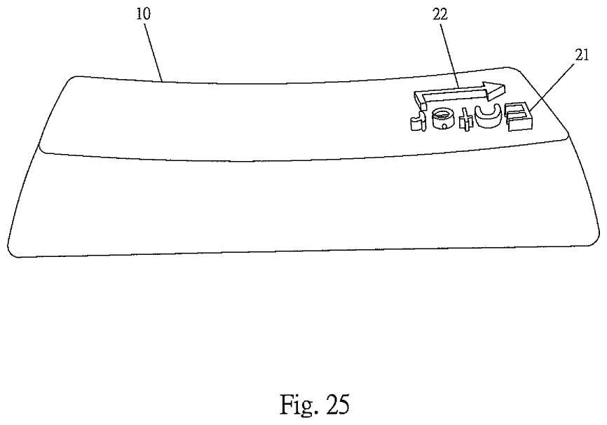

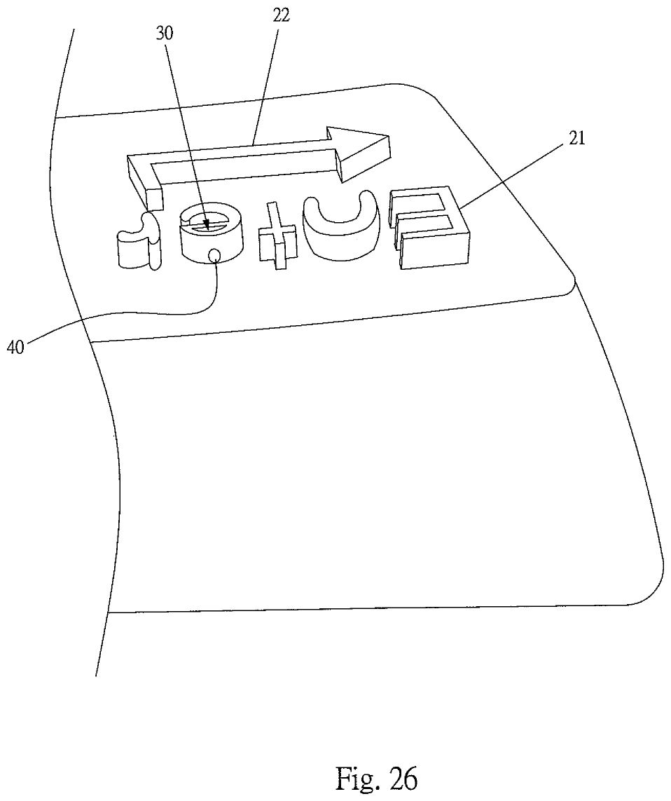

The present invention can be used widely in practical usages, as illustrated in FIGS. 21 to 26.

The structure of the present invention includes the following elements.

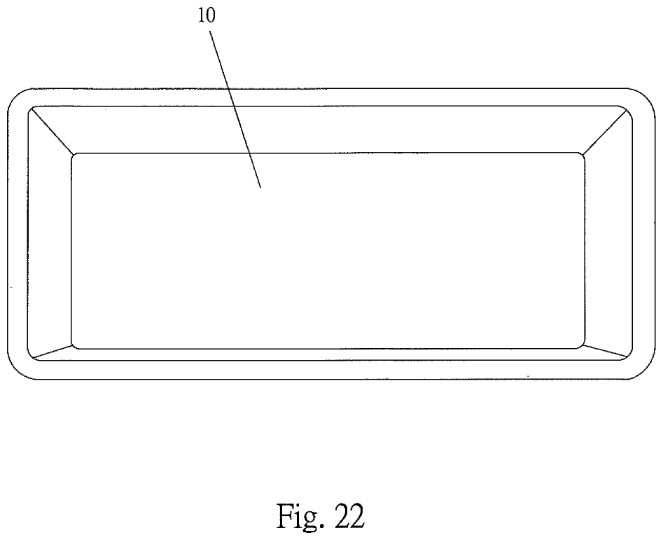

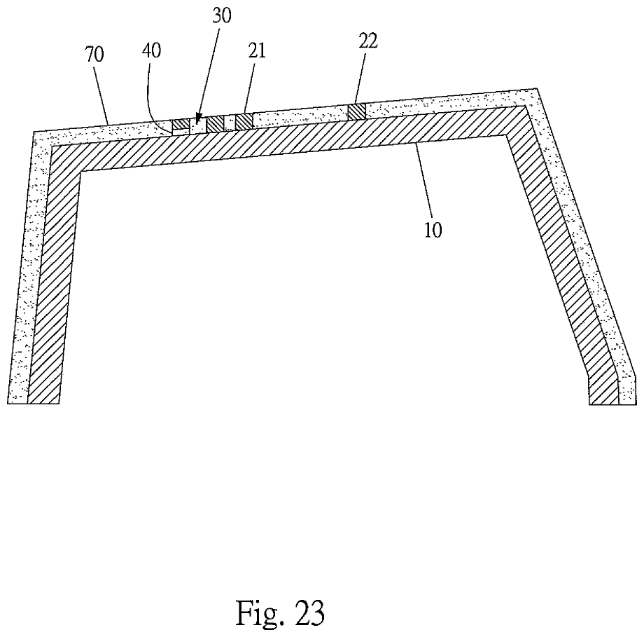

An inner bottom layer 10 (referring to FIGS. 22 to 26) is included. An outer surface of the inner bottom layer 10 has protruded textures 21 or drawings 22. The textures 21 or drawings 22 are formed with an enclosing space 30, that is: a part or whole of the textures 21 or drawings 22 is formed with an enclosing space 30. A through hole 40 is formed between a wall of the enclosing space 30 and an outer space (referring to FIGS. 23 to 26).

A masking layer 70 covers outer sides of the inner bottom layer 10 (referring to FIGS. 21 and 23). An outer surface of the masking layer 70 exposes the textures 21 and drawings 22 original on the inner bottom layer 10.

Preferably, a color of the masking layer 70 is different from that of the inner bottom layer 10 so that the textures 21 or drawings 22 on the outer surface of the inner bottom layer 10 clearly exposes on the surface of the masking layer 70.

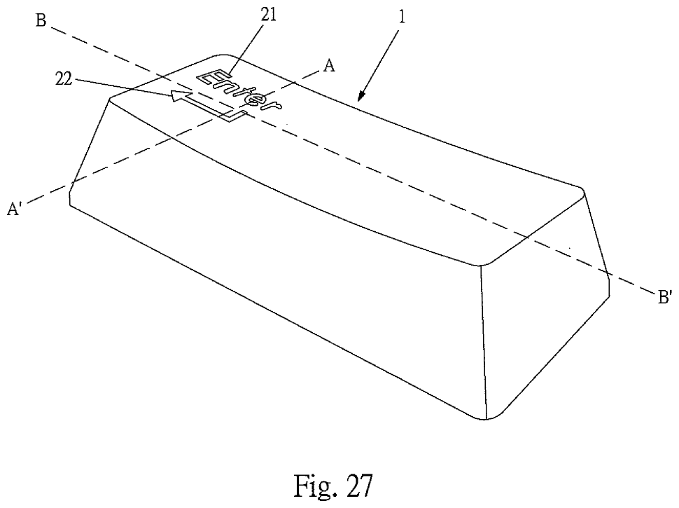

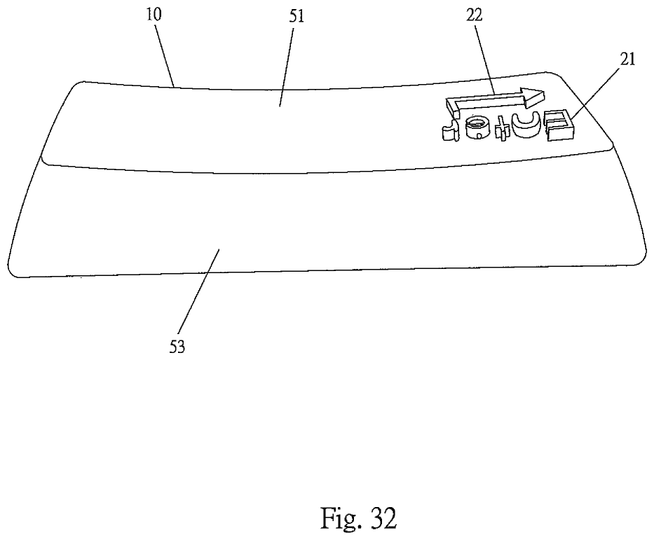

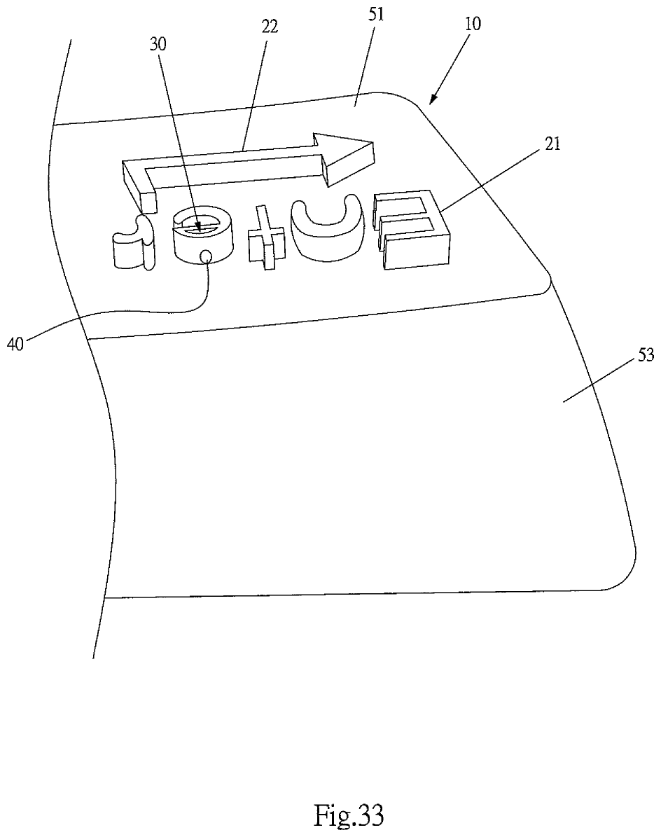

The present invention can be used widely in practical usages, as illustrated in FIGS. 27 to 33.

Another structure of the present invention includes the following elements.

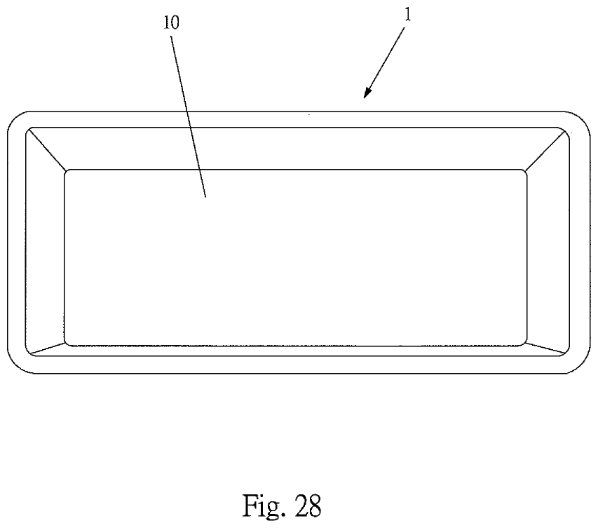

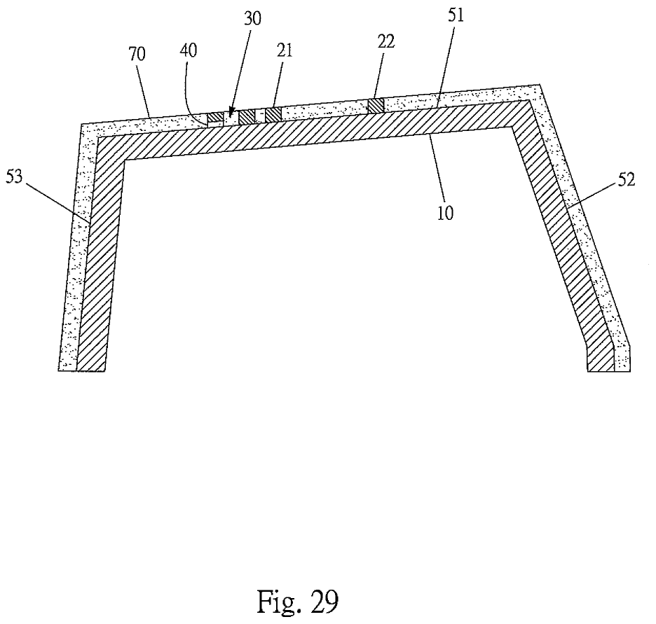

An inner bottom layer 10 (referring to FIGS. 28 to 33) is included. An outer surface of the inner bottom layer 10 has protruded textures 21 or drawings 22. The textures 21 or drawings 22 are formed with an enclosing space 30, that is: a part or whole of the textures 21 or drawings 22 is formed with an enclosing space 30. A through hole 40 is formed between a wall of the enclosing space 30 and an outer space (referring to FIGS. 29 to 33).

In this example, the texture 21 is a word “Enter”. The drawing 22 is an arrow. The “e” in “Enter” has an enclosing space 30. The enclosing space 30 has a through hole 40 which serves to communicate an interior and an outer space of the enclosing space 30 (referring to FIGS. 29 to 33).

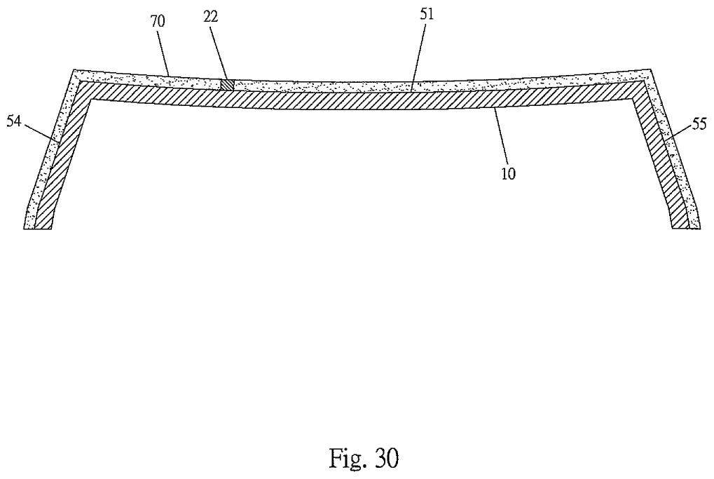

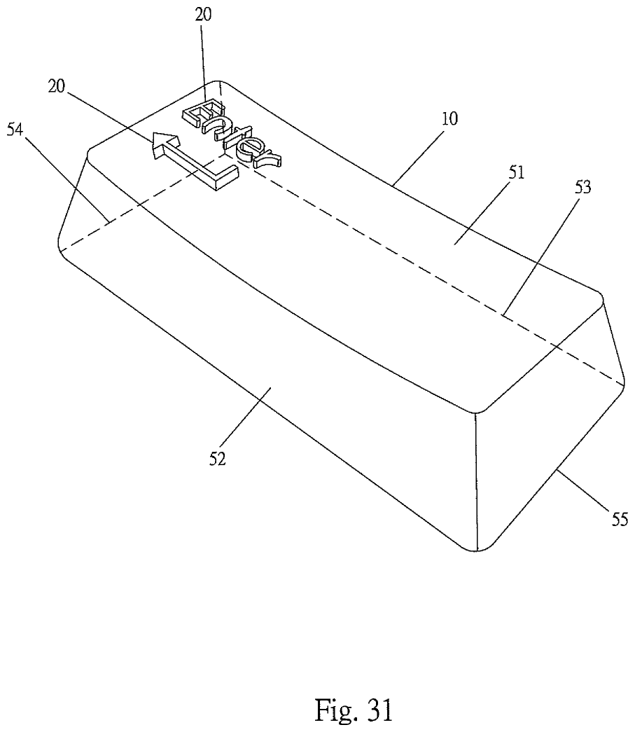

The inner bottom layer 10 has a trapezoidal shape. An upper side thereof has a pushing sheet 51 and four lateral sides 52, 53, 54 and 55 (referring to FIGS. 30 and 31) which are formed as an enclosed upper side with a lower opening.

A masking layer 70 covers the sheets 51, 52, 53, 54 and 55 of the inner bottom layer 10 (referring to FIGS. 29 to 30). An outer surface of the inner bottom layer 10 has protruded textures 21 or drawings 22 which exposes from the surface of the masking layer 70.

Preferably, the color of the masking layer 70 is different from that of the textures 21 and the drawings 22 on the inner bottom layer 10 so that the textures 21 and the drawings 22 clearly exposes on the surface of the masking layer 70.

In the prior art, the periphery and the interior of the inner bottom layer must be clamped by molds. Therefore, above mentioned rotation tool cannot be used to push the inner bottom layer to move forwards to cause the periphery and the interior of the inner bottom layer to be clamped by two molds. As a result, in the prior art, a worker is used to place the inner bottom layer to be between two molds for making the masking layer. This prior process is time consumed to cause the whole manufacturing time is prolonged. It is not economic.

Advantages of the present invention are that the inner bottom layer has textures or drawings on the surface thereof which includes at least one enclosing space. A through hole is formed on the enclosing space so that the masking material can be filled into the space between the outer mold and the inner mold. Then the masking material enters into the enclosing space through the through hole. As a result, only one mold (the outer mold) is necessary for forming the masking layer, while in the prior art, two molds are needed. The whole process can be completed mechanically without any manual operation. By the process of the present invention, the whole working time is reduced and the economic effect is promoted. This cannot be achieved by the prior art technology.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A two layer plastic device with textures or drawings thereon comprising:
an inner bottom layer; an outer surface of the inner bottom layer having protruded textures or drawings; the textures or drawings being formed with an enclosing space; that is: a part or whole of the textures or drawings is formed with an enclosing space; a through hole is formed between a wall of the enclosing space and an outer space; and
a masking layer covering outer sides of the inner bottom layer; an outer surface of the masking layer exposing the textures and drawings original on the inner bottom layer.

2. The two layer plastic device with textures or drawings thereon as claimed in claim 1, wherein a color of the masking layer is different from that of the inner bottom layer so that the textures or drawings on the outer surface of the inner bottom layer clearly exposes on the surface of the masking layer.

3. A two layer plastic device with textures or drawings thereon comprising:
an inner bottom layer; an outer surface of the inner bottom layer having protruded textures or drawings; the textures or drawings being formed with an enclosing space, that is: a part or whole of the textures or drawings being formed with an enclosing space; a through hole being formed between a wall of the enclosing space and an outer space; wherein the inner bottom layer has a trapezoidal shape; an upper side thereof has a pushing sheet and four lateral sides which are formed as an enclosed keypad with a lower opening; and
a masking layer covering the sheets of the inner bottom layer; an outer surface of the inner bottom layer having protruded textures or drawings which exposes from the surface of the masking layer.

4. The two layer plastic device with textures or drawings thereon as claimed in claim 3, wherein a color of the masking layer is different from that of the inner bottom layer so that the textures or drawings on the outer surface of the inner bottom layer clearly exposes on the surface of the masking layer.
